(19) United States
(12) Patent Application Publication
(10) Pub. No.: US 2016/0284180 A1
(43) Pub. Date: Sep. 29, 2016

(54) INSTRUSION-PREVENTING VERSATILE DEVICE

(71) Applicant: LAURA CAMPANA, MONCALIERI (IT)

(72) Inventor: LAURA CAMPANA, MONCALIERI (IT)

(21) Appl. No.: 15/035,696

(22) PCT Filed: Nov. 7, 2014
(86) PCT No.: PCT/IT2014/000294

§ 371 Date: May 10, 2016

(30) Foreign Application Priority Data
Nov. 22, 2013 (IT) TO2013A000950

(51) Int. Cl. G08B 13/14; G08B 6/00; G08B 5/22; G07C 9/00; G08B 3/10

(52) U.S. Cl. CPC G08B 13/1454; G07C 9/00158; G08B 3/10; G08B 5/22; G08B 6/00

(57) ABSTRACT

An intrusion-preventing versatile device (2) is described, to be placed inside envelopes (1), of the type capable of recognizing the rightful owner of the luggage. The device (1) is capable of being adapted to each envelope (1) through a removable sheath (22).

### BACKGROUND OF THE INVENTION

1) Field of the Invention

The present invention deals with an intrusion-preventing versatile device.

In particular, the invention deals with an intrusion-preventing versatile device to be placed inside a luggage, bag or the like, capable of recognizing the rightful owner of the luggage.

2) Background Art

Intrusion-preventing systems to be placed inside a bag are of three types: mechanical systems based on a lace or small cord fastened on one side to the bag and on the other side to garments of a person. In case of theft, the disconnection of the small cord generates the activation of an acoustic alarm, emitted by a loudspeaker placed inside the bag; systems equipped with dynamic sensor and acoustic signaling devices to supervise an unattended bag detecting and signaling possible non-authorized movements; systems equipped with telecommunication devices, such as a cellular phone or a smartphone connected to GPS, Bluetooth, WiFi, and capable of detecting when the bag moves away and sending an alarm.

The above described systems have the limit of not covering a simple intrusion, like pick-pocketing and withdrawal of objects from the bag worn by its rightful owner, intrusion in violation of one's privacy.

In order to solve this problem, the most recent prior art takes into account intrusion-preventing devices capable of recognizing the rightful owner of the luggage by means of a biometric sensor.

Patent document US2012279875 discloses a portable safety box whose opening is actuated by means of a programmable electronic key equipped with a biometric identifying device.

Patent document US2009226050 discloses an apparatus for the protection of an object through an access restriction controlled by a biometric system based on the identification of a fingerprint.

Other prior art devices are disclosed in US-A1-2006/087432 and U.S. Pat. No. 7,961,914.

Known object-protecting apparatuses managed through access restriction have the problem of their scarce versatility. In fact, there are no protecting apparatuses which can be easily detached from an object to be protected in order to be able to work and be used for other objects.

### SUMMARY OF THE INVENTION

Object of the invention therefore is creating an intrusion-preventing device capable of avoiding the simple intrusion, such as pick-pocketing and withdrawal of objects from a bag carried by its rightful owner and capable of being adapted to different pieces of luggage.

According to the present invention, this object is obtained, according to claim 1, through an intrusion-preventing versatile device to be placed inside envelopes, of the type capable of recognizing its rightful owner of the luggage, characterized in that it can be adapted to each envelope through a removable sheath.

Preferred embodiments and non-trivial variations of the present invention are the subject matter of the dependent claims.

It is intended that all enclosed claims are an integral part of the present description.

### BRIEF DESCRIPTION OF THE DRAWINGS

The present invention will be better described by some preferred embodiments thereof, provided as a non-limiting example, with reference to the enclosed drawings, in which:

FIG. 1 shows a view of a bag equipped with an intrusion-preventing versatile device according to the present invention;

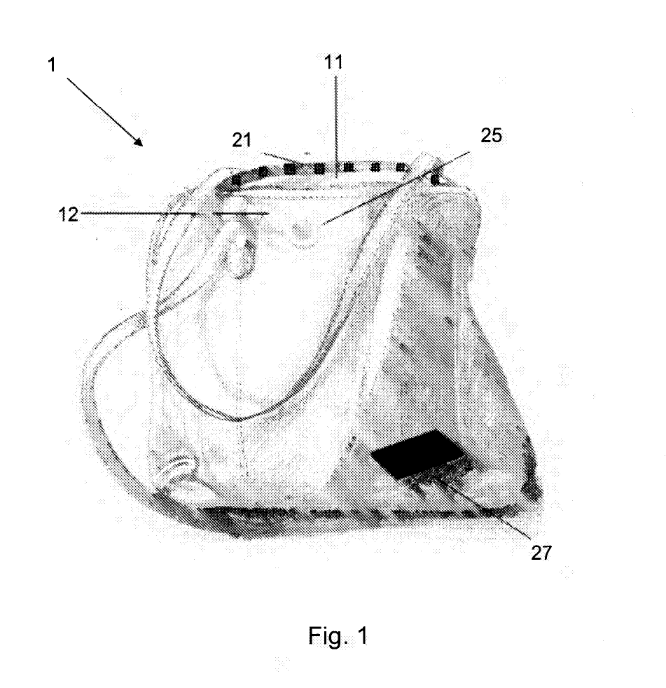

FIG. 2 shows a view of the intrusion-preventing versatile device of FIG. 1.

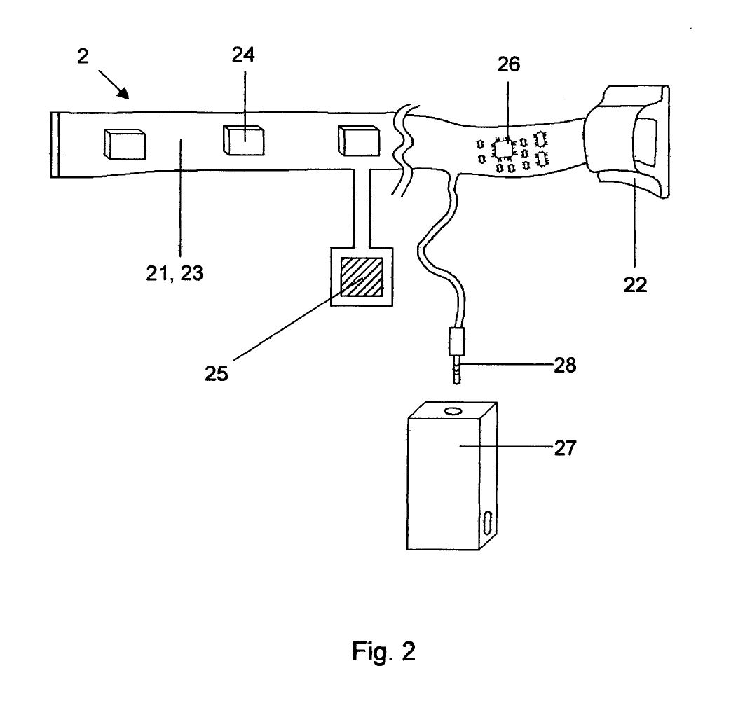

### DETAILED DESCRIPTION OF PREFERRED EMBODIMENTS

An envelope 1 contains several objects inserted therein from an opening composed of a pair of edges 11, 12, approached and kept joined by a closing system (not shown) such as zip, buttons and buttonholes, automatic buttons, belts and buckles, adhesive Velcro, etc.

An intrusion-preventing versatile device 2 comprises a flexible support 21 stretched and fastened inside the envelope 1 along the edges 11 and 12 of the opening through a sheath 22.

The sheath 22 is fastened inside the envelope 1 by means of removable elements (not shown) such as buttons, automatic buttons, adhesive Velcro, etc., sewed inside the edges 11 and 12 of the envelope 1.

The flexible support 21 supports a flexible printed circuit (PCB) 23 on which several surface-mounted (SMD) electronic components 24 are applied, together with activating means 25 of the device 2, and electronics 26.

The components 24 are communication interruption sensors, microphones, On/Off control switches, temperature sensors, etc.

The activating means 25 can be of various types; if, for example, they were composed of a simple pushbutton switch, they would allow turning the device 2 on through a simple pressure.

As preferred alternative, the activating means 25 can be composed of a biometric sensor, which therefore can be actuated only by the rightful owner of the device 2 for whom such sensor 25 has been set. The biometric sensor 25 can be a face reader, a fingerprint reader, etc.

The electronics 26 is composed of electronic (SMD) devices.

The flexible printed circuit 23 is connected through a connector 28 to a box 27 containing an electric energy supply and a sound, luminous, vibrating signaling device, etc.

The biometric sensor 25 is placed inside the envelope 1 in a position which can be easily reached by the owner to activate-deactivate the biometric recognition.

The features taken into account by the recognition system can be: fingerprints, iris color and size, retina, hand shape, hand palm, vascularization, vocal imprint, etc.

The detection system is activated through the biometric sensor 25, in any status of the container 1, therefore also open.

The intrusion-preventing versatile device 2 reaches the objectives of:
activating a biometric recognition system connected to the biometric sensor 25;
detecting an intrusion into the container 1 through an electronic circuit composed of sensors 24 controlled by the electronics 26;
activating an alarm system through the signaling device placed in the box 27.

The intrusion-preventing versatile device 2 also reaches the objective of be adapted to different types of containers 1. For example, the device 2 can be placed in the pocket of an overcoat, jacket, trousers, fastening the sheath 22 inside the pocket by means of adhesive Velcro and lacing the supply battery inside the pocket itself.

1. Intrusion-preventing versatile device (2) to be placed inside envelopes (1), of the type capable of recognizing the rightful owner of the luggage, characterized in that it can be adapted to each envelope (1) through a removable sheath (22), the sheath (22) being connected to a flexible support (21) equipped with a flexible printed circuit (23) on which electronic components (24), activating means (25) of the device (2), and a control electronics (26) are applied.

2. Intrusion-preventing versatile device (2) according to claim 1, characterized in that said activating means (25) are composed of a biometric sensor.

3. Intrusion-preventing versatile device (2) according to claim 1, characterized in that the sheath (22) is fastened to the edge of each envelope (1) through joining elements such as buttons, automatic buttons, adhesive Velcro.

4. Intrusion-preventing versatile device (2) according to claim 1, characterized in that the components (24) are communication interruption sensors, microphones, On/Off control switches, temperature sensors, and the biometric sensor (25) is a face reader, or a fingerprint reader.

5. Intrusion-preventing versatile device (2) according to claim 1, characterized in that the flexible printed circuit (23) is connected through a connector (28) to a box (27) containing an electric energy supply and a sound, luminous or vibrating signaling device.

6. Intrusion-preventing versatile device (2) according to claim 5, characterized in that the box (27) is placed inside each envelope (1).
